(19) United States
(12) Patent Application Publication
(10) Pub. No.: US 2015/0316286 A1
(43) Pub. Date: Nov. 5, 2015

(54) SYSTEM AND METHOD OF OPERATING AN HVAC CONTROLLER BASED ON A THIRD PARTY CALENDAR EVENT

(71) Applicant: Carrier Corporation, Farmington, CT (US)

(72) Inventor: Michael A. Roher, Ft. Wayne, IN (US)

(21) Appl. No.: 14/682,830

(22) Filed: Apr. 9, 2015

Related U.S. Application Data
(60) Provisional application No. 61/986,317, filed on Apr. 30, 2014.

(51) Int. Cl. F24F 11/00; G05D 23/19; G05B 15/02

(52) U.S. Cl. CPC F24F 11/0086; F24F 11/0012; F24F 11/0015; F24F 11/0034; F24F 11/006; G05B 15/02; G05D 23/1917; F24F 2011/0047; F24F 2011/0057; F24F 2011/0063; F24F 2011/0071; F24F 2011/0091

(57) ABSTRACT

A system and method of operating a controller in communication with a network to control one or more components of an HVAC system, wherein the controller operates the controller to access the network, receives a calendar event from the network, wherein the calendar event comprises data related to the occupancy of a structure environmentally controlled by the controller, stores the data from the calendar event within the controller, and operates the controller to control the one or more components of the HVAC system based on the data.

### CROSS REFERENCE TO RELATED APPLICATIONS

The present application is related to, and claims the priority benefit of U.S. Provisional Patent Application Ser. No. 61/986,317 file Apr. 30, 2014, the contents of which are hereby incorporated in their entirety into the present disclosure.

### TECHNICAL FIELD OF THE DISCLOSED EMBODIMENTS

The presently disclosed embodiments generally relate to heating, ventilation, and air-conditioning (HVAC) systems, and more particularly, to a system and method of operating a controller to control one or more components of an HVAC system based on third party calendar events.

### BACKGROUND OF THE DISCLOSED EMBODIMENTS

Programmable thermostats offer an improved ability to control the environment within a structure. More contemporary thermostats are available that include the ability to program a vacation schedule or separate set of vacation parameters. However, these thermostats are isolated devices that are not integrated into the rest of a consumer's lifestyle, and do not take advantage of tools that are in use today, such as personal organizers, web-based calendars, and mobile calendars. There is, therefore, a need for a device and method to integrate a consumer's planning tools to control the environment within a structure.

### SUMMARY OF THE DISCLOSED EMBODIMENTS

In one aspect, an HVAC system is provided. The HVAC system includes a controller in communication with at least one HVAC component. In one embodiment, the controller includes a processor, a memory, and at least one communication interface. In one embodiment, the at least one communication interface may be a wired or wireless connection. In one embodiment, the controller further includes a device interface, a user interface, and at least one sensor. The HVAC system further includes the controller in communication with at least one network. In one embodiment, the controller is in communication with the at least one network via a wired or wireless connection.

In one aspect, a method of operating a controller, in communication with at least one network, to control at least one HVAC component is provided. The method includes the step of operating the controller to access the at least one network.

The method further includes the step of receiving at least one calendar event from the network, wherein the at least one calendar event includes data related to the occupancy of a structure environmentally controlled by the controller. In one embodiment, the data includes a description, a start date, an end date, a start time, and an end time. In one embodiment, the data includes an operational mode for the at least one HVAC components. In one embodiment, the data includes a temperature set point. In one embodiment, the data includes a humidity set point.

The method further includes the step of storing the data from the calendar event within the controller. The method further includes the step of operating the at least one HVAC component based on the data.

In one aspect an HVAC system controller is provided. The HVAC system controller includes a processor, a memory operatively coupled to the processor, a communication interface operatively coupled to the processor, and executable software stored in the memory, the executable software is operable to access at least one network through the communication interface to monitor a first set of data from at least one calendar event related to a user's occupancy of a structure environmentally controlled by the controller and further operable to compare the first set of data to a second set of data from an external source and further operable to operate the HVAC system based on the first set of data and the second set of data

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic component diagram of a controller according to the present disclosure;

FIG. 2 is a schematic component diagram of a HVAC system; and

FIG. 3 is a schematic flow diagram of a method for operating a controller to control one or more components of an HVAC system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

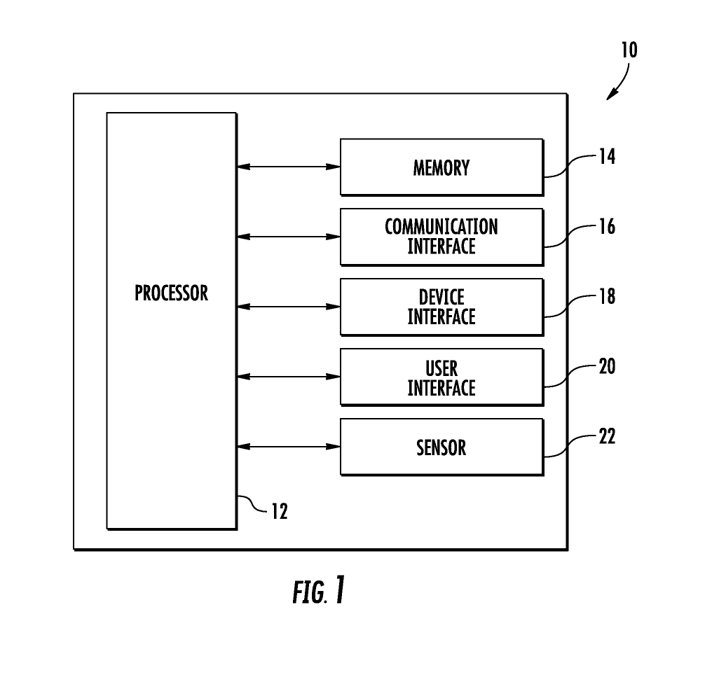

FIG. 1 is a schematic view of an embodiment of a controller 10. It will be appreciated that the controller 10 may include a computer, thermostat, indoor unit control board, outdoor unit control board, microprocessor, mobile device, etc. to name a few non-limiting examples. In one embodiment, the controller 10 includes a processor 12, a memory 14, for example read only memory (ROM) or electrically erasable programmable read only memory (EEPROM) to name two non-limiting examples, and at least one communication interface 16. The at least one communication interface 16 is configured to allow access to a network, later described herein. In one embodiment, the at least one communication interface 16 may be a wired or wireless connection. In one embodiment, the controller 10 further includes a device interface 18, a user interface 20, for example a liquid crystal display (LCD) to name one non-limiting example, and at least one sensor 22, for example a temperature sensor or humidity sensor to name a couple of non-limiting examples. The device interface 18 is configured to control one or more devices in communication with the controller 10, wherein the communication may be via a wired or wireless connection.

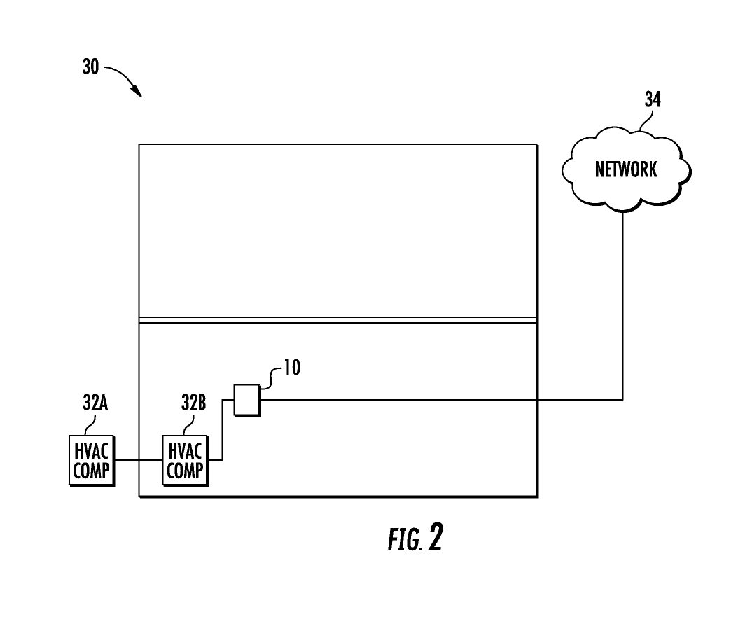

FIG. 2 is a schematic view of an HVAC system 30 utilizing the controller 10. The HVAC system 30 includes the controller 10 in communication with at least one HVAC component 32. The at least one HVAC component 32 is configured to condition the air within the structure 30. For example, the at least one HVAC component 32 may include a furnace, fan coil, heat pump, geothermal heat pump, humidifier, dehumidifier, indoor air quality system, etc., to name a few non-limiting examples. The HVAC system 30 further includes the controller 10 in communication with at least one network 34 to enable remote access and/or control of the controller 10 via another device such as a cell phone, computer, laptop computer, or tablet computer to name a few non-limiting examples. In one embodiment, the controller 10 is in communication with the at least one network 34 via a wired or wireless connection. As shown in FIG. 2, the controller 10 is in communication with a wireless local area network (LAN). It will be appreciated that the controller 10 may also be in communication wide area network or global network (WAN) including, for example, the Internet

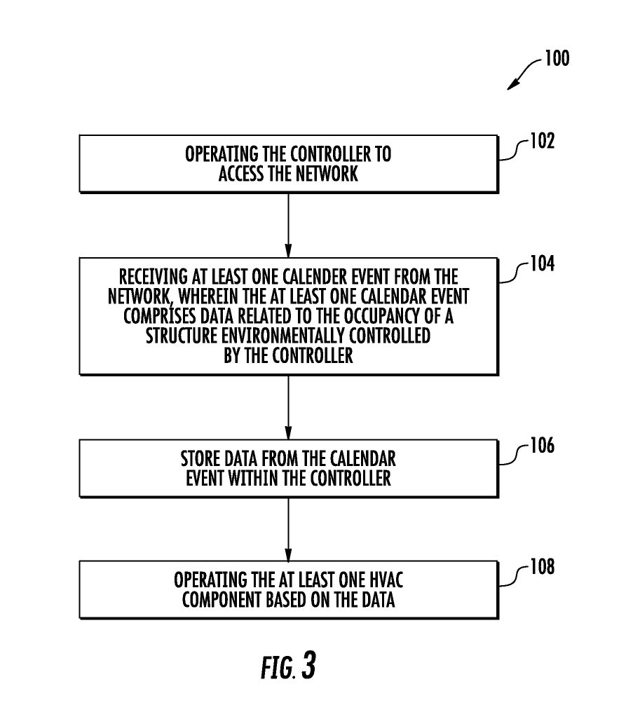

FIG. 3 illustrates a schematic flow diagram of an exemplary method 100 of operating a controller 10 in communication with at least one network 34 to control at least one HVAC component 32, for example outdoor HVAC component 32A and indoor HVAC component 32B, within the HVAC system 30. The method 100 includes the step 102 of operating the controller 10 to access the at least one network 34. For example, the processor 12 executes software stored in memory 14 to operate the at least one communication interface 16 to access the at least one network 34.

The method 100 further includes step 104 of receiving at least one calendar event from the network 34, wherein the at least one calendar event includes data related to the occupancy of the structure 30 environmentally controlled by the controller 10. For example, the processor 12 executes software stored in memory 14 to operate the at least one communication interface 16 to access a third party calendar application (e.g., GOOGLE® Calendar or MICROSOFT® OUTLOOK® Calendar to name a couple non-limiting examples) from the at least one network 34. In one embodiment, the controller 10 may receive data from the third party calendar application at pre-determined intervals. According to another embodiment, the controller 10 may receive data from the third party calendar application when prompted. In one embodiment, the data includes a description, a start date, an end date, a start time, and an end time. In one embodiment, the data includes an operational mode for the at least one HVAC components 34. In one embodiment, the data includes a temperature set point. In one embodiment, the data includes a humidity set point.

Once data from a calendar event is received by the controller 10, the controller 10 interprets the description to determine the type of event. Once the event type has been determined, the controller 10 interprets each remaining piece of data (for example by decoding text or Extensible Markup Language (XML), to name just two non-limiting examples) in the calendar event, and the controller 10 operates the at least one HVAC component 34, accordingly. It will be appreciated that other forms of readable data may be used. For example, a user may enter a description of “vacation,” a start date of “Mar. 31, 2014,” an end date of “Apr. 1, 2014,” a start time of “7:00 am” and an end time of “5:00 pm” within the third party calendar application. A user may also enter text within the notes or text field with respect to the operational mode, temperature set point, and humidity set point for the at least one HVAC components 32. Continuing with the example, a user may enter “heat to 68° F.” and “cool to 75° F.” It will be appreciated that additional data related to the capabilities of the at least one HVAC components 32 may be included. It will also be appreciated that the data may include data related to other systems within the structure 30, for example lighting, entertainment systems, and appliances to name a few non-limiting examples.

In one embodiment, the method 100 further includes step 106 of storing the data from the calendar event within the controller 10. For example, the processor 12 executes software stored in memory 14 to operate the at least one communication interface 16 to import the data from the third party calendar application and store the data within the memory 14. Continuing from the example above, the controller 10 will store the following data within the memory 14.

| Description | Vacation |
|---|---|
| Start Date | Mar. 31, 2014 |
| End Date | Apr. 1, 2014 |
| Start Time | 7:00 am |
| End Time | 5:00 pm |
| Text/Notes | heat to 68° F. |
| | cool to 75° F. |

The method 100 further includes step 108 of operating the at least one HVAC component 32 based on the data. The processor 12 executes software stored in memory 14 to send signals through the device interface 18 to operate the at least one HVAC component 32 based on the stored data. Continuing from the example above, if the at least one sensor 22 detects that the temperature within the structure 30 is below 68° F., the processor 12 will send a signal to one or more heating HVAC components to operate until the condition is satisfied. Additionally, if the at least one sensor 22 detects that the temperature within the structure 30 is above or 75° F., the processor will send a signal to one or more cooling HVAC components to operate until the condition is satisfied. The controller 10 will continue to operate the HVAC system 30 based on the data for the duration of the calendar event. At the conclusion of the calendar event, the controller 10 may revert back to its prior operating conditions (e.g. programmed schedule). At a predetermined interval, the method returns to step 102 to access the at least one network 34 in order to import newly added calendar events to the third party calendar application.

According to additional embodiments, controller 10 may monitor third party calendar applications along with actual settings or real time changes to the settings of thermostat controls and other HVAC system settings. The controller 10 may then analyze the data to determine correspondence between calendar entries and HVAC or thermostat settings. For example, if a user generally raises the temperature settings on a thermostat thirty to forty-five minutes after the end of the last appointment on the user's workday calendar, the controller 10 could recognize this and automatically adjust the temperature accordingly after such pattern is detected. Similarly, if a user typically lowers the temperature setting in a room concurrent with a calendar entry using the words “workout” or “exercise,” the controller 10 may automatically adjust the temperature settings accordingly.

According to further embodiments, this automatic learning function may be overridden by a user temporarily or permanently. Similarly, the self-learning feature may be supplemented by the user entering key words, time delays, advanced time settings, and temperatures. For example, a user may set the controller 10 to set the temperature and/or humidity level during any calendar event that uses a certain word in the title, body, or other portion of the event. For example, a user may set the controller 10 to detect the use of a word or phrase such as “returning home” or “away from home”, and to then adjust various HVAC settings to pre-defined values. This may allow the user to save time by not having to enter common settings each time a routine event occurs. The controller 10 may also adjust settings before or after specific calendar events based on self-learned or preset delays.

According to yet further embodiments, the controller 10 may use additional inputs for external sources with the self-learning feature. For example, the controller 10 may monitor a second set of data, such as external weather and/or external humidity to name a couple of non-limiting examples, along with a user's HVAC settings to determine if patterns exist. This may allow the HVAC system to adjust itself to maintain a desired comfort level by raising the temperature setting when external humidity drops or lowering the temperature setting during higher external humidity based on the user's past behavior during these conditions, by way of non-limiting example. While somewhat simplistic examples are given for the sake of clarity, one skilled in the art would understand that complex patterns may be discovered and adjusted for.

It will therefore be appreciated that the controller 10 may access a network 34 to import at least one calendar event from a third party calendar application and operate at least one HVAC component 32 based on the data to provide a user an easier integration between the user's lifestyle and managing the environmental conditions within their home.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A controller for controlling an HVAC system, the controller comprising:
a processor;
a memory operatively coupled to the processor;
a communication interface operatively coupled to the processor; and
executable software stored in the memory, the executable software operable to access at least one network through the communication interface to receive and store data from at least one calendar event related to a user's occupancy of a structure environmentally controlled by the controller and further operable to operate the HVAC system based on the data from the calendar event.

2. The controller of claim 1, wherein the communication interface is selected from a group consisting of: wireless and wired.

3. The controller of claim 1, further comprising a user interface operatively coupled to the processor, an equipment interface operatively coupled to the processor and at least one sensor operatively coupled to the processor.

4. The controller of claim 1, wherein the data comprises a date and a time.

5. The controller of claim 1, wherein the executable software accesses the at least one network at periodic intervals.

6. The controller of claim 1, wherein the executable software accesses the at least one network when prompted.

7. The controller of claim 4, wherein the HVAC system comprises an outdoor HVAC component and an indoor HVAC component.

8. The controller of claim 7, wherein the data comprises an operational mode of an HVAC system.

9. The controller of claim 7, wherein the data comprises a temperature set point.

10. The controller of claim 8, wherein the data comprises a humidity set point.

11. An HVAC system comprising:
a system controller in communication with at least one network; and
at least one HVAC component in communication with the system controller;
wherein the system controller is configured to access the at least one network to receive and store data from at least one calendar event related to a user's occupancy of a structure environmentally controlled by the system controller; and
wherein the system controller operates the at least one HVAC component based on the data from the calendar event.

12. The HVAC system of claim 11, wherein the system controller is in communication with the network via a connection selected from a group consisting of: wireless and wired.

13. The HVAC system of claim 9, wherein the system controller is in communication with the at least one HVAC component via a connection selected from a group consisting of: wireless and wired.

14. The HVAC system of claim 11, wherein the system controller accesses the at least one network at periodic intervals.

15. The HVAC system of claim 11, wherein the system controller accesses the at least one network when prompted.

16. The HVAC system of claim 11, wherein the system controller comprises a thermostat.

17. The HVAC system of claim 11, wherein the data comprises a date and a time.

18. The HVAC system of claim 17, wherein the data comprises an operational mode of the at least one HVAC component.

19. The HVAC system of claim 18, wherein the data comprises a temperature set point.

20. The HVAC system of claim 18, wherein the data comprises a humidity set point.

21. A method of operating a controller in communication with a network to control one or more components of an HVAC system, the method comprising the steps of:
operating the controller to access the network;
receiving at least one calendar event from the network, wherein the at least one calendar event comprises data related to the occupancy of a structure environmentally controlled by the controller;
operating the controller to control the one or more components of the HVAC system based on the data from the at least one calendar event.

22. The method of claim 21, wherein the method further comprises storing the data from the calendar event within the controller;

23. The method of claim 21, wherein the data comprises a date and a time.

24. The method of claim 21, wherein the calendar event is received at periodic intervals.

25. The method of claim 21, wherein the calendar event is received when prompted.

26. The method of claim 21, wherein the data comprises an operational mode of the one or more components of the HVAC system.

27. The method of claim 21, wherein the data comprises a temperature set point.

28. The method of claim 21, wherein the data comprises a humidity set point.

29. A controller for controlling an HVAC system, the controller comprising:
a processor;
a memory operatively coupled to the processor;
a communication interface operatively coupled to the processor; and
executable software stored in the memory, the executable software operable to access at least one network through the communication interface to monitor a first set of data from at least one calendar event related to a user's occupancy of a structure environmentally controlled by the controller and further operable to monitor a second set of data from an external source and further operable to operate the HVAC system based on the first set of data and the second set of data.

30. A controller comprising:
a processor configured to;
receive an environmental input from at least one sensor;
receive schedule input from a user calendar; and
determine at least one HVAC system set point on the received environmental input and the received schedule input; and
a control unit, capable of setting an HVAC system set point according to the determined at least one HVAC system set point

31. The controller of claim 30, wherein the schedule input comprises text information other than numerical set point information.
